(19) United States
(12) Patent Application Publication
(10) Pub. No.: US 2025/0313066 A1
(43) Pub. Date: Oct. 9, 2025

(54) ENVIRONMENTAL CONTROL SYSTEM WITH MIXED BLEED AND AMBIENT PACK

(71) Applicant: Hamilton Sundstrand Corporation, Charlotte, NC (US)

(72) Inventors: Aiden Coutin, Ogden, UT (US); Louis J. Bruno, Ellington, CT (US)

(21) Appl. No.: 19/018,509

(22) Filed: Jan. 13, 2025

Related U.S. Application Data
(60) Provisional application No. 63/574,068, filed on Apr. 3, 2024.

(51) Int. Cl. B60H 1/34

(52) U.S. Cl. CPC B60H 1/3414

(57) ABSTRACT

An air conditioning system of a vehicle includes a plurality of inlets operable to receive a plurality of mediums. The plurality of inlets include a first inlet operable to receive a first medium and a second inlet operable to receive a second medium. The air conditioning system additionally include an outlet and a thermodynamic device operably coupled to the plurality of inlets and to the outlet. The thermodynamic device includes a compressor, a first turbine, and a second turbine, operably coupled by a shaft. The second turbine includes a plurality of flow paths. The plurality of flow paths of the second turbine are fluidly coupled to an upstream component in parallel relative to a flow of the first medium.

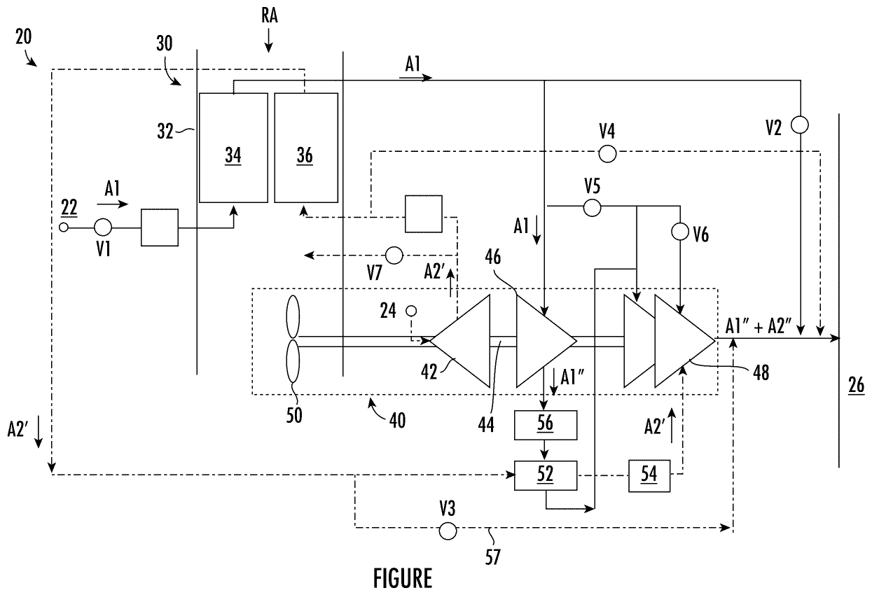

### CROSS-REFERENCE TO RELATED APPLICATIONS

This application claims the benefit of U.S. Application No. 63/574,068, filed Apr. 3, 2024, the contents of which are incorporated by reference herein in its entirety.

### BACKGROUND

Embodiments of the disclosure relate to environmental control systems, and more specifically to an environmental control system of an aircraft.

In general, contemporary air condition systems are supplied a pressure at cruise that is approximately 30 psig to 35 psig. The trend in the aerospace industry today is towards systems with higher efficiency. One approach to improve airplane efficiency is to eliminate the bleed air entirely and use electrical power to compress outside air. A second approach is to use lower engine pressure. The third approach is to use the energy in the bleed air to compress outside air and bring it into the cabin. Unfortunately, each of these approaches provides limited efficiency with respect to engine fuel burn.

### SUMMARY

According to an embodiment, an air conditioning system of a vehicle includes a plurality of inlets operable to receive a plurality of mediums. The plurality of inlets include a first inlet operable to receive a first medium and a second inlet operable to receive a second medium. The air conditioning system additionally include an outlet and a thermodynamic device operably coupled to the plurality of inlets and to the outlet. The thermodynamic device includes a compressor, a first turbine, and a second turbine, operably coupled by a shaft. The second turbine includes a plurality of flow paths. The plurality of flow paths of the second turbine are fluidly coupled to an upstream component in parallel relative to a flow of the first medium.

In addition to one or more of the features described above, or as an alternative to any of the foregoing embodiments the first turbine and the second turbine are arranged in series relative to the flow of one of the plurality of mediums.

In addition to one or more of the features described above, or as an alternative to any of the foregoing embodiments an outlet of the first turbine is fluidly coupled to an inlet of one of the plurality of flow paths of the second turbine.

In addition to one or more of the features described above, or as an alternative to any of the foregoing embodiments a water extractor is fluidly coupled to and arranged downstream from the outlet of the first turbine and fluidly coupled to an arranged upstream from the inlet of one of the plurality of flow paths of the second turbine.

In addition to one or more of the features described above, or as an alternative to any of the foregoing embodiments the first turbine and the water extractor, in combination, form a mid-pressure water separator.

In addition to one or more of the features described above, or as an alternative to any of the foregoing embodiments at least one of the plurality of flow paths of the second turbine is fluidly coupled to both the first inlet and the second inlet.

In addition to one or more of the features described above, or as an alternative to any of the foregoing embodiments in a first mode, the plurality of flow paths of the second turbine receive the first medium and the second medium, in combination, and in another mode, the plurality of flow paths of the second turbine receive only the first medium.

In addition to one or more of the features described above, or as an alternative to any of the foregoing embodiments the compressor and the second turbine are fluidly coupled in series relative to the flow of the second medium.

In addition to one or more of the features described above, or as an alternative to any of the foregoing embodiments a high-pressure water separator is located downstream from the compressor and upstream from the second turbine relative to the flow of the second medium.

In addition to one or more of the features described above, or as an alternative to any of the foregoing embodiment a ram air circuit includes at least one ram heat exchanger. The at least one ram heat exchanger being fluidly coupled to the plurality of inlets.

In addition to one or more of the features described above, or as an alternative to any of the foregoing embodiments the at least one ram heat exchanger includes a primary heat exchanger fluidly coupled to the first inlet and a secondary heat exchanger fluidly coupled to the second inlet.

In addition to one or more of the features described above, or as an alternative to any of the foregoing embodiments the at least one ram heat exchanger is fluidly coupled to an outlet of the compressor and is fluidly connected to an inlet of the second turbine.

In addition to one or more of the features described above, or as an alternative to any of the foregoing embodiments a bypass conduit extends from a location downstream of the at least one ram heat exchanger and upstream from the inlet of the second turbine relative to the flow of the second medium.

According to an embodiment, a method of operating an air conditioning system includes receiving a first medium and a second medium at a plurality of inlets, during a first mode, expanding the first medium at a first turbine and a second turbine in series and expanding the second medium at the second turbine, and during a second mode, expanding the first medium at the second turbine. The second turbine include a plurality of flow paths, and during the second mode, the first medium is expanded via each of the plurality of flow paths.

In addition to one or more of the features described above, or as an alternative to any of the foregoing embodiments during the second mode, the second medium bypasses the second turbine.

In addition to one or more of the features described above, or as an alternative to any of the foregoing embodiments during the second mode, the first medium bypasses the first turbine.

In addition to one or more of the features described above, or as an alternative to any of the foregoing embodiments during the first mode, removing moisture from the first medium between the first turbine and the second turbine.

In addition to one or more of the features described above, or as an alternative to any of the foregoing embodiments during both the first mode and the second mode, the second medium is compressed at a compressor. The compressor is operably coupled to the first turbine and the second turbine via a shaft.

In addition to one or more of the features described above, or as an alternative to any of the foregoing embodiments during the second mode, removing moisture from the second medium after compressing the second medium and before expanding the second medium at the second turbine.

### BRIEF DESCRIPTION OF THE DRAWINGS

The subject matter is particularly pointed out and distinctly claimed in the claims at the conclusion of the specification. The forgoing and other features, and advantages thereof are apparent from the following detailed description taken in conjunction with the accompanying drawings in which:

The FIGURE is a schematic diagram of an environmental control system according to an embodiment.

### DETAILED DESCRIPTION

A detailed description of one or more embodiments of the disclosed apparatus and method are presented herein by way of exemplification and not limitation with reference to the FIGURE.

Embodiments herein provide an environmental control system of an aircraft that receives multiple mediums from different sources and uses energy from one or more of the mediums to operate the environmental control system and to provide cabin pressurization and cooling at a high fuel burn efficiency. The mediums described herein are generally types of air; however, it should be understood that other mediums, such as gases, liquids, fluidized solids, or slurries are also contemplated herein.

With reference now to the FIGURE, an example of a schematic diagram of a portion of an environment control system, such as an air conditioning system or pack for example, is depicted according to a non-limiting embodiment. Although the air conditioning system (ACS) or ACS pack 20 is described with reference to an aircraft, alternative applications, such as another vehicle for example, are also within the scope of the disclosure. As shown, the ECS 20 may be configured to receive a first medium A1 at a first inlet 22. In embodiments where the ACS 20 is used in an aircraft application, the first medium A1 is bleed air, which is pressurized air originating from, i.e., being “bled” from, an engine or auxiliary power unit of the aircraft. It shall be understood that one or more of the temperature, humidity, and pressure of the bleed air can vary based upon the compressor stage and revolutions per minute of the engine or auxiliary power unit from which the air is drawn.

The ACS 20 may alternatively or additionally be configured to receive a second medium A2 at a second inlet 24. In an embodiment, the second medium A2 is fresh air, such as outside air for example. The outside air can be procured via one or more scooping mechanisms, such as an impact scoop or a flush scoop for example. Thus, the second inlet 24 can be considered a fresh or outside air inlet. In an embodiment, the second medium A2 is ram air drawn from a portion of a ram air circuit. Generally, the second medium A2 described herein is at an ambient pressure equal to an air pressure outside of the aircraft when the aircraft is on the ground and is between an ambient pressure and a cabin pressure when the aircraft is in flight. The ACS 20 may be operable to provide a conditioned form of at least one of the first medium A1 and the second medium A2 to a volume 26 during normal operation. In an embodiment, the ACS 20 is operable to provide a conditioned form of a mixture of the first medium A1 and the second medium A2 to the volume 26.

The ACS 20 may include a RAM air circuit 30 including a shell or duct, illustrated schematically at 32, within which one or more heat exchangers are located. The shell 32 can receive and direct a medium, such as ram air AR for example, through a portion of the ACS 20. The one or more heat exchangers are devices built for efficient heat transfer from one medium to another. Examples of the type of heat exchangers that may be used, include, but are not limited to, double pipe, shell and tube, plate, plate and shell, adiabatic shell, plate fin, pillow plate, and fluid heat exchangers.

The one or more heat exchangers arranged within the ram air duct 32 may be referred to as ram heat exchangers. In the illustrated, non-limiting embodiment, the at least one ram heat exchanger includes a first or first heat exchanger 34 and a second or second heat exchanger 36. Within the heat exchangers 34, 36, ram air, such as outside air for example, acts as a heat sink to cool a medium passing there through, for example the first medium A1 and/or the second medium A2. Although a ram air circuit 30 having only two heat exchangers 34, 36 is illustrated, it should be understood that embodiments having only a single heat exchanger, or alternatively, more than two heat exchangers are also contemplated herein. Further, although the plurality of ram air heat exchangers 34, 36 are illustrated as being arranged in series relative to a flow through the ram air circuit 30, it should be understood that in other embodiments, the plurality of heat exchanger may be arranged in parallel or some combination of series and parallel.

The ACS 20 may additionally include at least one thermodynamic device 40. A thermodynamic device 40 is a mechanical device that includes components for performing thermodynamic work on a medium (e.g., extracts work from or applies work to the first medium A1, the second medium A2 by raising and/or lowering pressure and by raising and/or lowering temperature). Examples of a thermodynamic device 40 include an air cycle machine, a two-wheel air cycle machine, a three-wheel air cycle machine, a four-wheel air cycle machine, etc.

As shown, the thermodynamic device 40 includes a compressor 42 and at least one turbine operably coupled by a shaft 44. In the illustrated, non-limiting embodiment, the thermodynamic device 40 includes a first turbine 46 and a second turbine 48. However, embodiments including a single turbine or more than two turbines are also within the scope of the disclosure.

A compressor, such as compressor 42, is a mechanical device configured to raise a pressure of a medium and can be driven by another mechanical device (e.g., a motor or a medium via a turbine). Examples of compressor types include centrifugal, diagonal or mixed-flow, axial-flow, reciprocating, ionic liquid piston, rotary screw, rotary vane, scroll, diaphragm, air bubble, etc.

A turbine, such as turbine 46 and 48 for example, is a mechanical device that expands a medium and extracts work therefrom (also referred to as extracting energy). This extracted energy is transmitted to the shaft 44 of the turbine and the other components operably coupled thereto, such as a compressor 42 for example. In an embodiment, the second turbine 48 is a dual entry turbine. As shown, the dual entry turbine 48 may be configured to receive flows of different mediums, or in some embodiments, multiple flows of the same medium. A dual entry turbine typically has multiple nozzles, each of which is configured to receive a distinct flow of medium at a different entry point, such that multiple flows can be received simultaneously. For example, the turbine 48 can include a plurality of inlet flow paths, such as an inner flow path associated with the first nozzle and an outer flow path associated with the second nozzle, to enable mixing of the medium flows at the exit of the turbine 48. The inner flow path can be a first diameter, and the outer flow path can be a second diameter. Further, the inner flow path can align with one of the first or second nozzles, and the outer flow path can align with the other of the first or second nozzles.

The ACS 20 includes a fan 50. A fan 50 is a mechanical device that can force via push or pull methods air through the shell of the ram air duct, across at least a portion of the ram air heat exchangers. The fan 50 may be a component separate from a thermodynamic device 40 and is driven by any suitable means, such as a motor for example. However, in other embodiments, such as shown in the FIGURE, the fan 50 may be operably coupled to the shaft 44 of the thermodynamic device 40. In such embodiments, the fan 50 may be driven by energy extracted within the at least one turbine 46, 48.

The elements of the ACS 20 are connected via valves, tubes, pipes, and the like. Valves (e.g., flow regulation device or mass flow valve) are devices that regulate, direct, and/or control a flow of a medium by opening, closing, or partially obstructing various passageways within the tubes, pipes, etc. of the system. Valves can be operated by actuators, such that flow rates of the medium in any portion of the system can be regulated to a desired value. For instance, a first valve V1 may be configured to control a supply of the first medium A1 to the system 20. A second valve V2 may be operable to allow a portion of a medium output from the ram air circuit 30, such as the first medium A1, to bypass the remainder of the ACS 20 including the thermodynamic device 40, water extractor 56 and condensing heat exchanger 52. Similarly, a third valve V3 arranged within a bypass conduit 57 may be operable to allow a portion of a medium output from the ram air circuit 30, such as the second medium A2, to bypass the remainder of the ACS 20 including the condensing heat exchanger 52, water extractor 54, and thermodynamic device 40. A fourth valve V4 may control a flow of medium, such as the second medium A2, at a location downstream from the compressor 42 and upstream from the ram air circuit 30 to bypass the remainder of the ACS 20. A fifth valve V5 may function as a bypass valve causing the flow of first medium A1 output from the ram air circuit to bypass the first turbine 46, water extractor 56, and condensing heat exchanger 52 and be provided directly to the first nozzle of the second turbine 48. A sixth valve is selectively operable to supply a flow of the first medium A1 to the second nozzle of the second turbine 48. Surge control of the compressor may be provided by a seventh valve V7.

The ACS 20 illustrated and described herein is operable in a plurality of modes, such as based on a condition of the vehicle. A first mode of the ACS 20 may be associated with operation of the vehicle on the ground. For example, the ECS 20 may be operable in a first mode such as during ground and low altitude flight conditions, for example ground idle, taxi, take-off, and hold conditions. During this first mode, a flow of first medium A1 is received at the first inlet 22. From the inlet 22, ozone may be removed from the first medium A1 and the resulting first medium A1 is provided to an inlet of the primary heat exchanger 34. A flow of ram air RA, moving through the ram air duct 32 by the fan 50, is provided to the primary heat exchanger 34 to cool the first medium A1. From the outlet of the heat exchanger 34, the cool first medium A1 is provided to an inlet of the first turbine 46 of the thermodynamic device 40. Within the first turbine 46, the first medium A1 is expanded and work is extracted therefrom to drive the compressor 42 via the shaft 44. This extraction of work from the first medium A1 within the turbine 46 creates an expanded first medium A1″.

During its expansion within the first turbine 46, the first medium A1 is further cooled and moisture within the first medium A1 is condensed. In an embodiment, the expanded first medium A1″ provided at the outlet of the first turbine 46 has a temperature close to freezing. Directly downstream from the outlet of the first turbine 46 may be the water extractor 56. Accordingly, within the water extractor 56, any free moisture in the expanded first medium A1″ is removed. The first turbine 46 and the water extractor 56 in combination may be considered a mid-pressure water separator.

The resulting dry, cool, expanded first medium A1″ output from the water extractor 56 may be delivered to a condensing heat exchanger 52. Within the condensing heat exchanger 52, the expanded first medium A1″ is configured to absorb heat from the second medium A2. From an outlet of the condensing heat exchanger 52, the resulting expanded first medium A1″ may be provided to an inlet of the second turbine 48, such as via the first nozzle, where it is further expanded and more work is extracted therefrom. Accordingly, in the first mode, the first medium A1 may be provided to the first turbine 46 and the second turbine 48 in series. Work extracted from the expanded first medium A1′ within the second turbine 48 may also be used to drive the compressor 42 via the shaft 44. From the second turbine 48, the further expanded first medium A1″ may be delivered to one or more loads, such as the cabin 26 for example.

At the same time, a flow of the second medium A2 may be provided to the ACS 20 via the second inlet 24. As shown, the second medium A2 is delivered to an inlet of the compressor 42. The act of compressing the second medium A2 heats it. The resulting compressed second medium A2′ output from the compressor 42 is provided to the secondary heat exchanger 36 of the ram air circuit 30. A flow of ram air RA, moving through the ram air duct 32 driven by the fan 50, is provided to the secondary heat exchanger 36 to cool the compressed second medium A2′. The flow of ram air RA used to cool the compressed second medium A2′ within the second heat exchanger 36 may be the same ram air or different ram air than used to cool the first medium A1 within the primary heat exchanger 34.

The ACS 20 may include a high-pressure water separator associated with the second medium A2. The high-pressure water separator may be formed by the condensing heat exchanger 52 and a water extractor 54 in combination. In such embodiments, within the secondary heat exchanger 36, the compressed second medium A2′ is cooled to a nearly ambient temperature. From the secondary heat exchanger 36, this cool second medium A2′ is provided to the condensing heat exchanger 52, where it is cooled by the flow of expanded first medium A1″ output from the first turbine 46. As the compressed second medium A2′ is cooled within the condensing heat exchanger 52, moisture is condensed within the compressed second medium A2′. The compressed second medium A2′ then enters the water extractor 54 where any free moisture in the compressed second medium A2′ is removed. This cool, dry, compressed second medium A2′ then enters the second turbine 48, such as via a second nozzle for example, where it is expanded and work is extracted therefrom to form an expanded second medium A2″. The act of extracting work from the compressed second medium A2′ within the second turbine 48 cools the compressed second medium A2′. From the second turbine 48, the resulting expanded second medium A2″ may be delivered to one or more loads, such as the cabin 26 for example.

The expanded first medium A1″ output form the second turbine 48 and the expanded second medium A2″ may be mixed together at a mixing point, such as at the outlet of turbine 48 for example, or at a location downstream therefrom. This mixture of expanded first medium A1″ and the expanded second medium A2″ may be delivered to one or more loads, such as the cabin 26.

The ACS 20 may also be operable in a second mode. The second mode may be associated with “high-altitude” operation suitable for use during flight conditions such as at high altitude cruise, climb, and descent flight conditions. Operation of the ACS 20 in the high-altitude mode may be similar to operation on the ground. The flow of the first medium through the ACS 20 in the second mode may be identical to that in the first mode. However, the second medium A2 is not expanded in the second turbine 48. In the second mode, the second medium A2 is delivered from the second inlet 24 to the compressor 42 where the second medium is compressed to form a compressed second medium A2′. From the compressor 42, the compressed second medium A2′ is delivered to the secondary heat exchanger 36 of the ram air circuit 30. Within the secondary heat exchanger 36, the compressed second medium A2′ is cooled by the flow of ram air RA. In the second mode, the valve V3 is open such that the cooled compressed second medium A2′ output from the secondary heat exchanger 36 bypasses the high-pressure water separator (heat exchanger 52 and water extractor 54 in combination) and the second turbine 48. Accordingly, the flow output from the secondary heat exchanger 36 is provided directly upstream from an outlet of the ACS 20, where the compressed second medium A2′ is mixed with the flow of expanded first medium A1″ output from the second turbine 48 before being delivered to one or more loads.

However, in some embodiments, in the second mode, the flow of the first medium A1 may not be identical to the flow described with respect to the first mode. For example, valve V5 may be open, and valve V6 may be closed. Because the valve V5 is open, the cool first medium A1 output from the primary heat exchanger 34 bypasses the first turbine 46 and is delivered to the second turbine 48. Because the second medium A2 bypasses the second turbine 48, only the first medium A1 is expanded therein and output therefrom as a flow of expanded first medium A1″.

A third mode of operation of the ACS 20 may be associated with failure operation. In the event of a failure of a pressurized air system and/or of another ACS pack during flight, a remaining functional ACS pack, such as ACS pack 20 for example, may be operated to meet the demands of the aircraft. To maintain the pressure and/or flow rate requirements associated with operation in such a failure mode, the remaining operational ACS pack 20 may be operated in a “single pack” or third mode of operation. Operation in the third mode may be similar to operation in the second, high-altitude mode. However, during operation in the third mode, valve V6 in addition to valve V3, and in some embodiments V5, are open.

In the third mode, a flow of first medium A1 is received at the first inlet 22. The flow of first medium A1 received at the inlet 22 in the third mode is increased compared to the flow of first medium A1 received in the first and/or second modes. From the inlet 22, the first medium A1 is provided to the primary heat exchanger 34 where the first medium A1 is cooled. Because both valves V5 and V6 are open, the flow of the first medium A1 from the primary heat exchanger 34 is divided between a first nozzle associated with the first flow path within the second turbine 48 and a second nozzle associated with the second path within the second turbine 48. Accordingly, the first medium A1 is provided to the inner and outer flow path of the second turbine 48 in parallel. Within the second turbine 48, the first medium A1 is expanded and work is extracted therefrom to drive the compressor 42 via the shaft 44. This extraction of work from the first medium A1 within the turbine 48 creates an expanded first medium A1″.

The second medium A2 received at the second inlet 24 is provided to the compressor 42 where the second medium A2 is compressed to form a compressed second medium A2′. From the compressor 42, the compressed second medium A2′ is delivered to the secondary heat exchanger 36 of the ram air circuit 30. Within the secondary heat exchanger 36, the compressed second medium A2′ is cooled by the flow of ram air RA. Because valve V3 is open, the cooled compressed second medium A2′ output from the secondary heat exchanger 36 bypasses the high-pressure water separator (heat exchanger 52 and water extractor 54 in combination) and the second turbine 48. Accordingly, the flow output from the secondary heat exchanger 36 is provided directly upstream from an outlet of the ACS 20, where the compressed second medium A2′ is mixed with the two flows of expanded first medium A1″ output from the second turbine 48 before being delivered to one or more loads.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An air conditioning system of a vehicle, the air conditioning system comprising:
a plurality of inlets operable to receive a plurality of mediums, the plurality of inlets including a first inlet operable to receive a first medium and a second inlet operable to receive a second medium;
an outlet;
a thermodynamic device operably coupled to the plurality of inlets and to the outlet, the thermodynamic device including a compressor, a first turbine, and a second turbine, operably coupled by a shaft, wherein the second turbine includes a plurality of flow paths; and
wherein the plurality of flow paths of the second turbine are fluidly coupled to an upstream component in parallel relative to a flow of the first medium.

2. The air conditioning system of claim 1, wherein the first turbine and the second turbine are arranged in series relative to the flow of one of the plurality of mediums.

3. The air conditioning system of claim 2, wherein an outlet of the first turbine is fluidly coupled to an inlet of one of the plurality of flow paths of the second turbine.

4. The air conditioning system of claim 3, further comprising a water extractor fluidly coupled to and arranged downstream from the outlet of the first turbine and fluidly coupled to an arranged upstream from the inlet of one of the plurality of flow paths of the second turbine.

5. The air conditioning system of claim 4, wherein the first turbine and the water extractor, in combination, form a mid-pressure water separator.

6. The air conditioning system of claim 1, wherein at least one of the plurality of flow paths of the second turbine is fluidly coupled to both the first inlet and the second inlet.

7. The air conditioning system of claim 4, wherein in a first mode, the plurality of flow paths of the second turbine receive the first medium and the second medium, in combination, and in another mode, the plurality of flow paths of the second turbine receive only the first medium.

8. The air conditioning system of claim 1, wherein the compressor and the second turbine are fluidly coupled in series relative to the flow of the second medium.

9. The air conditioning system of claim 8, further comprising a high-pressure water separator located downstream from the compressor and upstream from the second turbine relative to the flow of the second medium.

10. The air conditioning system of claim 1, further comprising a ram air circuit including at least one ram heat exchanger, the at least one ram heat exchanger being fluidly coupled to the plurality of inlets.

11. The air conditioning system of claim 10, wherein the at least one ram heat exchanger includes a primary heat exchanger fluidly coupled to the first inlet and a secondary heat exchanger fluidly coupled to the second inlet.

12. The air conditioning system of claim 10, wherein the at least one ram heat exchanger is fluidly coupled to an outlet of the compressor and is fluidly connected to an inlet of the second turbine.

13. The air conditioning system of claim 12, further comprising a bypass conduit extending from a location downstream of the at least one ram heat exchanger and upstream from the inlet of the second turbine relative to the flow of the second medium.

14. A method of operating an air conditioning system comprising:
receiving a first medium and a second medium at a plurality of inlets;
during a first mode, expanding the first medium at a first turbine and a second turbine in series and expanding the second medium at the second turbine; and
during a second mode, expanding the first medium at the second turbine, wherein the second turbine include a plurality of flow paths, and during the second mode, the first medium is expanded via each of the plurality of flow paths.

15. The method of claim 14, wherein during the second mode, the second medium bypasses the second turbine.

16. The method of claim 14, wherein during the second mode, the first medium bypasses the first turbine.

17. The method of claim 14, wherein during the first mode, removing moisture from the first medium between the first turbine and the second turbine.

18. The method of claim 14, wherein during both the first mode and the second mode, the second medium is compressed at a compressor, the compressor being operably coupled to the first turbine and the second turbine via a shaft.

19. The method of claim 18, wherein during the second mode, removing moisture from the second medium after compressing the second medium and before expanding the second medium at the second turbine.
